(19) United States
(12) Patent Application Publication
(10) Pub. No.: US 2015/0237419 A1
(43) Pub. Date: Aug. 20, 2015

(54) RADIATION EXPOSURE MONITORING DEVICE AND SYSTEM

(71) Applicant: Senaya, Inc., Boston, MA (US)

(72) Inventors: Brian Lee, Boston, MA (US); Dadi Setiadi, Edina, MN (US)

(21) Appl. No.: 14/618,556

(22) Filed: Feb. 10, 2015

Related U.S. Application Data
(60) Provisional application No. 61/941,309, filed on Feb. 18, 2014.

(51) Int. Cl. H04Q 9/00

(52) U.S. Cl. CPC H04Q 9/00; H04Q 2209/40

(57) ABSTRACT

A radiation exposure monitoring system comprising wireless dosimeter devices that are very energy efficient and that can communicate remotely with a remote host that in turn performs the dose calculations from the raw data transmitted by the wireless dosimeter devices. The system has a plurality of wireless dosimeter devices not equipped with a display screen, each comprising a integrated dosimeter, a control unit being in turn connected to a wireless transceiver for the transmission of data representative of the radiation detected by each dosimeter; at least one remote host comprising a wireless transceiver suitable for communicating with at least some of the transceivers of the dosimeter devices and with at least one remote host for tracking the wireless dosimeter.

### CROSS-REFERENCE TO RELATED APPLICATION

This application claims priority to U.S. provisional application 61/941,309 filed Feb. 18, 2014, the entire disclosure of which is incorporated herein for all purposes.

### BACKGROUND

Wireless radiation exposure monitors (e.g., dosimeter devices) and systems are known. Unfortunately, many have limited operational range, are constrained by their battery power, and for some monitors, any signal level detected by the dosimeter is considered to be a ‘non reliable’ alarm, at the unsafe level of exposure, thus providing lack of advanced warning. Many of these monitors and systems require daily battery changes, a sleep mode of operation and a related triggering mechanism.

There are many different types of radiation detectors or dosimeter devices for monitoring exposure to hazardous ionizing radiation, such as x-rays, gamma rays, beta rays (high energy electrons), alpha rays (high energy helium ions) and neutrons. There are several radiation measurement technologies and methodology that are used for existing dosimeter devices, such as Geiger meters or counters (GM), Thermo Luminescent Dosimeter devices (TLD), Optically Stimulated Luminescence (OSL) dosimeter devices, electronic dosimeter devices, quartz or carbon fiber electrets, and other solid-state radiation measurement devices.

Thermo Luminescent Dosimeter (TLD) badges are the most common type of wearable dosimeter devices for ionizing radiation. TLD incorporates a material (i.e., lithium fluoride) that retains deposited energy from radiation. TLD badges are read using heat, which causes the TLD material to emit light that is detected by a TLD reader (calibrated to provide a proportional electric current). Significant disadvantages of TLD badges are that the signal of the device is erased or zeroed out during read-out, substantial time is required to obtain the reading, and the dosimeter devices must be returned to a processing laboratory for readout.

Optically Stimulated Luminescence (OSL) badges use an optically stimulated luminescent material (OSLM) (e.g., aluminum oxide) to retain radiation energy. Tiny crystal traps within the OSL material trap and store energy from radiation exposure. The amount of exposure is determined by illuminating the crystal traps with a stimulating light of one color (e.g., green) and measuring the amount of emitted light of another color (e.g., blue). OSL dosimeter devices can be read in the field using small, field-transportable readers, however, the readers are still too large, slow and expensive to allow individual, real-time readings in the field.

Electronic dosimeter devices are battery powered and typically incorporate a digital display or other visual, audio or vibration alarming capability. These instruments often provide real-time dose rate information to the wearer. For routine occupational radiation settings in the U.S., electronic dosimeter devices are mostly, but not strictly, used for access control and not for dose of record. However, electronic dosimeter devices are impractical for widespread use due to their high cost.

Quartz or carbon fiber electrets are cylindrical electroscopes where the dose is read by holding it up to the light and viewing the location of the fiber on a scale through an eyepiece at one end. A manually powered charger is needed to zero the dosimeter. The quartz fiber electret is an important element of many state emergency plans. For example, some plans call for emergency responders to be issued a quartz fiber electret along with a card for recording the reading every 30 minutes, as well as a cumulative dosimeter badge or wallet card. While they are specified for use in nuclear power plant emergencies, the NRC does not require them to be NVLAP accredited, only that they be calibrated periodically.

Solid state sensors use solid-phase materials such as semiconductors to quantify radiation interaction through the collection of charge in the solid state masses. As the radiation particle travels through the solid state mass, electron-hole pairs are generated along the particle path. The motion of the electron-hole pair in an applied electric field generates the basic electrical signal from the detector.

There are two main categories of solid state sensors, active and passive. Active sensors often use a semiconductor that is biased by an externally powered electric field that requires constant power. The active sensors generate electric pulses for each radioactive particle striking the sensor. These pulses must be continuously counted to record the correct radiation dose. A loss of power results in no dose being measured. Active solid state sensors are typically made from silicon and/or other semiconductor materials. Passive solid state sensors utilize an ‘on device’ charged medium that maintains the electric field necessary to separate the electron-hole pairs without drawing external power. Passive solid state dosimeter devices often use a ‘floating gate,’ where the gate is embedded within the detection medium so it is electronically isolated.

An example of a passive solid state dosimeter uses a PMOS transistor as the detector element and the associated electronics measure the change in the threshold voltage required to maintain the device at a specified operating point. This passive solid state dosimeter measures the effect of radiation on the gate oxide rather than the silicon, but using the results to infer a silicon dose. The main problem with this degradation dosimeter technique is that it is indirect, in that, the devices do not measure radiation dose but the radiation effects upon a specific device. Not all devices degrade in the same way or at the same rate and the understanding of rate and annealing effects become critical. These indirect radiation effects make the interpretation of the device output prone to serious error. A pre-irradiation test of this passive solid state dosimeter is usually performed to establish an operational curve that represents the degradation as a function of the dose received.

Another example of an indirect measurement-type solid state sensor is a scintillator, in which energy absorbed from incident radiation or charged particles is converted into light. A silicon photodiode attached to the scintillation-type detector can read this light. Various materials can be used as scintillators depending on variable such as energy range, type of radiation to be detected, environmental constraints, etc. Examples of suitable materials include bismuth germanate (Bi₄Ge₃O₁₂), cadmium tungstate (CdWO₄), and cesium iodide.

Even with all these options for radiation detection, it is desirable to have a single system that can monitor, in real time, different aspects of at least one municipality system continuously and communicate with several entities at the same time.

### SUMMARY

This disclosure provides occupational and/or environmental dosimeter devices, systems, and methods of radiation detection. A dosimeter is a portable, signal emitting device configured for placement in pre-existing premises, such as a room, building, outdoor area, or other contaminated area. This disclosure pertains to real time, remote, self-powered, compact, wireless and secure radiation dosimeter devices with long battery life that provide real time radiation measurement and result display.

Systems of this disclosure include at least one wireless dosimeter device, typically multiple devices, and a remote host. The wireless dosimeter device includes multiple sensor devices (e.g., integrating electronic radiation sensor, motion sensor, temperature sensor, chemical sensor, wind sensor), wireless transmitter(s) (e.g., LTE/BLE/ZigBee), and a GPS for the simultaneous detection and wireless transmission of ionizing radiation data, motion data and global position. The remote host receives data related to the level of radiation and other sensor information, and location of the devices, analyzes the data, makes decision analysis, and sends new instruction(s) and activation to the dosimeter device(s). The radiation detection systems are simple to deploy, efficient and economical.

The systems can automatically calculate stay time in an area, which may allow the user to more effectively plan activities based on dynamic calculations of radiation exposure, prior to receiving a maximum allowable radiation dose. The automated exposure monitoring systems described herein may include a relatively simple user interface for operation by an emergency responder with little or no training in health physics. Generally, automatic calculation of stay time is less prone to error in comparison to human calculations. Stay time calculations made using dynamic conditions may be much more accurate as calculated times are based on one or more real-time radiation fields. Furthermore, dynamic calculations may be updated regularly as the user moves from one radiation zone to another.

While using the radiation exposure monitoring system, first responder may be provided with a more accurate and expedient determination of stay time. This may be advantageous while responding to a radiation incident or working in varying radiation fields. In turn, more accurate and expedient stay time determination may also provide increased safety and allow better planning of activities while inside radiation areas.

The radiation exposure monitoring system described herein may also provide a constantly updated readout of how much time the user can stay in the current radiation field based on the user's pre-selected or pre-established maximum allowable dose. As discussed herein, visual, audible or vibration indicators may provide additional warning when the user is at or approaching a maximum stay time.

These and various other features and advantages will be apparent from a reading of the following detailed description.

### BRIEF DESCRIPTION OF THE DRAWING

The disclosure may be more completely understood in consideration of the following detailed description of various implementations of the disclosure in connection with the accompanying drawing, in which:

FIG. 1 is a schematic diagram of a system having a plurality of wireless dosimeter devices and a remote receiver/host.

FIG. 2 is a schematic diagram of an implementation of a wireless dosimeter device.

FIG. 3 is a schematic cross-sectional diagram of an implementation of an integrated scintillator dosimeter.

FIG. 4 is a flow diagram of an example method for monitoring radiation exposure with a system having a wireless dosimeter device.

FIG. 5 is a flow diagram of an example method for collecting sensor data from a wireless dosimeter device.

FIG. 6 is a flow diagram of an example method for connecting a wireless dosimeter device.

FIG. 7 is a flow diagram of an example method for activating a wireless dosimeter device.

FIG. 8 is a flow diagram of an example method with a wireless dosimeter device.

### DETAILED DESCRIPTION

Radiation exposure events can occur when a Radiological Dispersal Device (RDD), Improvised Nuclear Device (IND), or another source of radioactive material is released and contaminates a given area. In response to radiation events, one would like to know how safe it is (real-time radiation level), and how long it is safe to stay in a radiation area (total radiation exposure over time), for example, while conducting rescue or first aid activities. Typically, this “stay time” calculation is performed manually based on radiation readings from hand-held meters. These calculations require expert training and know-how, take time to compute, and are prone to human error, especially in an emergency response situation. The dosimeter devices of this disclosure can calculate total radiation exposure over time and estimate when the exposure will near unacceptable.

During these radiation events, the real-time and total radiation exposure of first responders and health-care workers is typically monitored. However, monitoring the exposure of the general public, i.e., of potentially tens of thousands of people, presents a more difficult problem. The systems of this disclosure can be used to monitor hundreds, and even thousands, of people for real-time and total radiation exposure.

Even after the contamination has been reduced or eliminated, there may be a need for dosimeter monitoring for individual members of the public as well as large numbers in a particular area, such as workers. Because site restoration can be a lengthy project and, to minimize disruption to society, it is often desired to allow the public, e.g., residents, to have access to certain areas before cleanup is completed. As an individual moves through a contaminated area, it would be valuable to know the dose and time of exposure at each location visited. The dosimeter devices of this disclosure can monitor and record radiation levels and exposure by location. The devices reduce the need for model-based estimates of dose, and avoid unnecessary area restrictions by providing a geographic map of the dynamic dose distribution reconstructed from a large number of dosimeter devices collecting dose event data over the potentially still-contaminated area.

Some dosimeter devices are “passive,” having a strip of radiation-sensitive material. When a photon passes through this strip, the latter is exposed in the same manner as a photographic film. These badge-type devices are distributed in rooms, on appliances, or on other locations where radioactivity has to be monitored. At the end of a defined time period, the passive are collected and sent to a laboratory for analysis. This can often take several days, so that the knowledge of a radioactivity incident is necessarily offset in time relative to the occurrence of the incident itself. This is how the incorrect adjustment of radiotherapy instruments happens to have been detected only several days later.

In addition to this detection delay, the passive badges used require scrupulous management for their positioning, their collection, the referencing of their position, their sending to the analysis laboratories, and collection of the results and the drafting of the reports. The time spent in managing the environmental dosimeter measurement can represent several full-time workers for the contaminated area.

Other dosimeter devices are “active,” having an electrical power supply linked to a measurement system sensitive to radiation. As soon as the detector receives any radiation, it calculates the dose received and sends the result to a display screen, providing an immediate report. Additionally, an active dosimeter can be connected to a data collection terminal where the radiation report can be downloaded and stored. An advantage of such an electronic dosimeter is that it provides an immediate calculation of the detected radiation dose, without having to wait several days or weeks.

However, there are several barriers to being able to readily replace passive dosimeter badges with active dosimeter devices. Common barriers include the high cost of the active dosimeter devices, and a lack of infrastructure to collect and verify measured data by the active dosimeter devices. In this disclosure, a low cost solid-state dosimeter device and methods of designing it are described. The data collection and verification for such a dosimeter device can be achieved through qualification and certification process using autonomous wireless data sharing with certified test labs and institutes using cloud services.

What is needed is a radiation exposure monitoring device system with the following characteristics: (1) small and easily carried or mounted to fixed structures or mobile transports; (2) short deployment time (<24 hours installation); (3) capable of measuring a dose event, including the measured amplitude or intensity of the event, time of the event, location of the event, ambient temperature, motion of the detector and proximity to other detectors; (4) accurate calculation of the dose, e.g., the Personal Dose Equivalent, over a wide dose range, wide energy range, and large angles of incidence; (5) ability to display the measured dose event, e.g., in order to alert anomalous events, and transmit the measured dose over networks; (6) ability to track and report dose events in the field over extended periods of time without replacing or externally charging the power source; (7) ability to map the distribution of dose over a geographic area, e.g., to identify anomalous dose distributions, display temporal profile monitoring and simulation, and profile progression mapping, e.g., to dynamically track sources and to alert Authorized Personnel of anomalous dose events; (8) capable of monitoring in real time 24/7; (9) provide real time decision making capability; and (10) to provide a system that can read a plurality of dosimeter devices in different locations or at a common location. The systems of this disclosure can provide all this, and more.

In the following description, reference is made to the accompanying drawing that forms a part hereof and in which are shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Described and shown herein are radiation exposure monitoring systems, dosimeter devices for measuring environmental radioactivity, and various methods for using environmental dosimeter devices and systems. The systems are capable of detecting and quantifying a measurable event, such as an exposure to ionizing radiation, by recording, e.g., the time, location, ambient temperature, motion and intensity of the event. The systems can also accurately calculate the equivalent absorbed dose from the radiation event, and map the distribution of the event by using data collected from a large number of dosimeter devices over a wireless network. The systems are capable of predicting the probable severity of the event by analysis of the collected sensor network data.

The systems for radiation exposure monitoring allow one to know centrally and almost immediately the dose detected by all the dosimeter devices deployed in an area. The systems, which use wireless communications, are easy to deploy in pre-existing premises without having to carry out any significant installation work, are efficient because some of the maintenance and calibration can be performed automatically and remotely, and are cost effective because no installation/deinstallation management is required and only a limited annual maintenance is needed, which limits the production of waste to the dosimeter devices, which may be changed annually.

The systems include a plurality of wireless dosimeter devices, some of which can be equipped with a display screen, each dosimeter having an integrated micro dosimeter and a control unit operably connected to a wireless transceiver for the transmission of data representative of the radiation detected by the dosimeter device. All of the wireless dosimeter devices communicate with a remote host that can perform dose calculations from the raw data transmitted by the wireless dosimeter devices. In some implementations, some dosimeter devices can be equipped with a radioactive dose computer, capable of calculating the radiation dose from the raw data picked up by the dosimeter device. The systems may also have a memory for storing the doses calculated by the remote host. Further, the systems may also have an alarm that can be activated by the remote host in the case where a calculated dose exceeds a predefined threshold. The remote host can also track the physical location of the dosimeter devices.

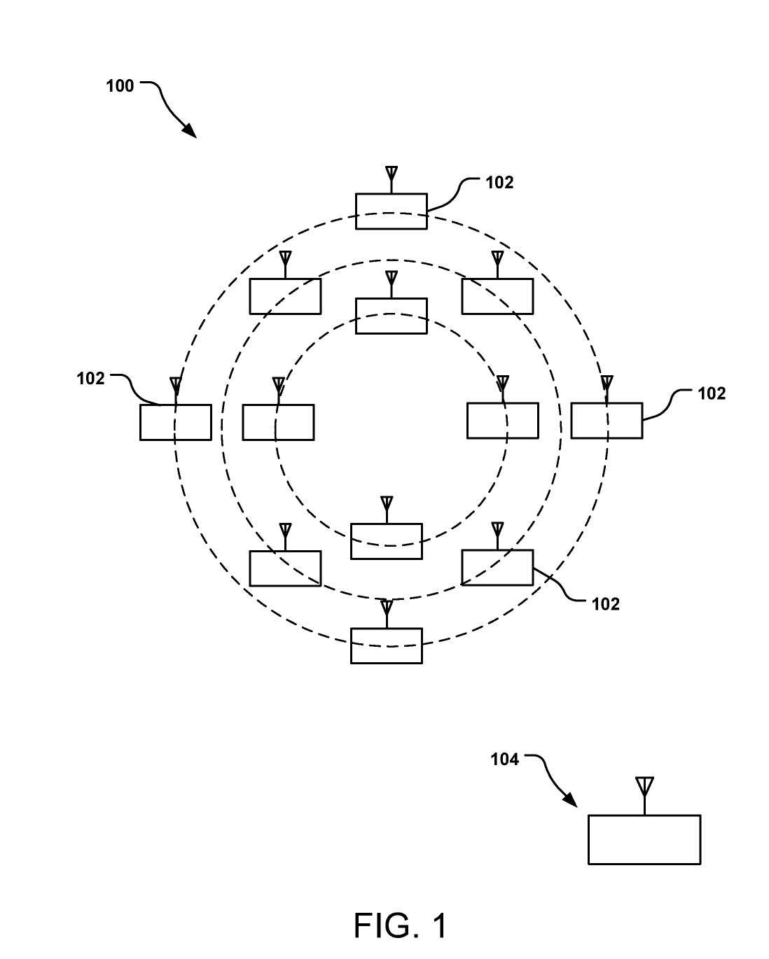

FIG. 1 illustrates an exemplary radiation exposure monitoring system 100. The radiation monitoring system 100 and variations thereof includes at least one wireless dosimeter device and a remote host receiver for receiving the radiation data from the wireless dosimeter device(s). The remote host may also receive location data from the dosimeter device(s).

Radiation exposure monitoring system 100 has at least one wireless dosimeter device 102 associated with (e.g., located on) a premise. System 100 may have, for example ten dosimeter devices 102, twenty dosimeter devices 102, or more. Wireless dosimeter device 102 is an active RF tag, having the capability to actively transmit and/or provide interactive information to remote host 104. Remote host 104 can be operably connected to a computer, server, or display, or remote host 104 can be integral with a computer, server, display, etc. Remote host 104 may be at a central station or communicate with a central station.

The radiation monitoring system 100 uses an established wireless communication network to convey information to remote host 104, information such as the location of each wireless dosimeter device 102 and/or radiation data. Examples of wireless RF communication networks with which monitoring system 100 can function include ZigBee, Bluetooth Low Energy (BLE), WiFi (sometimes referred to as WLAN), LTE, and WiMax. In some implementations, a cellular or cellular frequency communication network, such as CDMA/GMS, may be additionally or alternately used. Wireless dosimeter device 102 can be configured to switch between RF and cellular communication networks, depending on availability of the communication network.

Remote host 104 can receive the radiation dose calculated by each wireless dosimeter device 102, but, alternatively and preferred, remote host 104 calculates the radiation dose from the raw data transmitted by each wireless dosimeter device 102. In such an implementation, wireless dosimeter devices 102 do not themselves calculate the received dose, which results in reduced cost of dosimeter device 102, reduced size of dosimeter device 102, and extended battery life of dosimeter device 102.

Remote host 104 may be an autonomous remote host receiver. An autonomous remote host includes a receiver, a wireless network (e.g. RF or cellular), a public data network and a distributed data server. The remote host is configured to communicate with wireless dosimeter device 102 and the wireless network, which in turn is configured to communicate with the public data network, which is configured to communicate with the distributed data server.

System 100 is easy to deploy, is energy efficient and allows for a “real-time” monitoring of multiple environmental dosimeter devices by the remote host. System 100 can also be very easily adapted to the operating conditions and opportunities of the premises being monitored. System 100 can be used for surveillance of an area, looking for sources of radiation. For example, dosimeter device 102 can be attached to a person or a vehicle that moves through the surveillance area. As the dosimeter device moves through the area, its location and radiation reading are sent to remote host 104. System 100 may provide a map of the distribution of dose over a geographic area, or progression of dose over time, or identify anomalous dose distributions based on the data stored in the memory and the level of radiation instantaneously measured by the wireless dosimeter.

System 100 can be configured to calculate a maximum stay time for a user in an area. System 100 can include a processor and software code for calculating a maximum stay time based on the data related to the level of radiation measured by one or more wireless dosimeter devices 102 and remote host 104 can relay the maximum stay time.

For example, remote host 104 may include a numeric display that indicates the maximum stay time recommended or allowed. Alternately, a progression of graduated lights or other non-numeric output may indicate the maximum stay time. The device may be configured to indicate the maximum stay time by an on-going alert at a pre-selected interval. In an example, the indicator may provide an escalating warning as the maximum stay time is approached. This escalating warning may include, for example, lights and/or sounds and/or motion (e.g., vibration), which may be simultaneously activated, alternately activated, or progressively activated with respect to one another. Escalating warning lights may include strobe lights, flashing lights, progressive LEDs going from a “safe” period of time to various “warning” periods to cumulate in an “exit” period. The “exit” period may include a predetermined buffer time to allow the user to safely leave the radiation area.

In addition to providing escalating warnings, system 100 (e.g., remote host 104) may be configured to provide warnings of increasing urgency as the remaining stay time is reduced. For example, warnings may be provided at increasing frequency (i.e., reduced times between warnings) as the stay time approaches zero. The increased frequency of warnings may be provided for any of the warnings (e.g., lights, sounds or vibrations). If voice-synthesized warnings are provided, such warnings may be provided at increasing frequencies. In addition, the verbiage of the warnings can also be changed to convey the sense of increasing urgency as the maximum stay time approaches zero. Furthermore, system 100 can additionally transmit an alarm, for example, in the case of a threshold overshoot, a worrying trend, a network failure or a failure of the cells/batteries.

Example steps that system 100, by having at least one wireless dosimeter device 102 and remote host 104, can accomplish include measuring the level of radiation in the area of the wireless dosimeter; transmitting the data related to the level of radiation from the wireless dosimeter to the remote host; calculating the maximum stay time based on the data related to the level of radiation; and indicating the maximum stay time to the user.

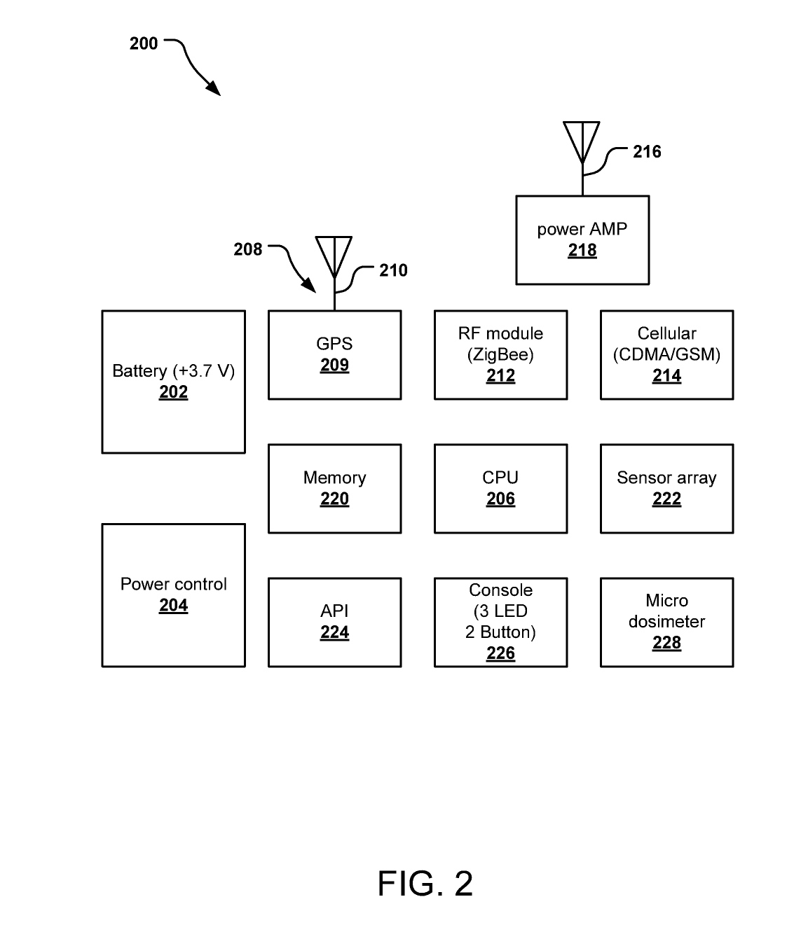

A particular implementation of a wireless dosimeter device is illustrated in FIG. 2 as device 200. Wireless dosimeter device 200 of FIG. 2, together with a remote host (e.g., remote host 104 of FIG. 1), forms a radiation exposure monitoring system (e.g., system 100 of FIG. 1). FIG. 2 and the following discussion are directed to one particular wireless dosimeter device. It is understood that other configurations and designs of the wireless dosimeter device may be used for a system.

Wireless dosimeter device 200 includes a battery 202, which may be a single use battery or a rechargeable battery. Examples of suitable batteries include NiCad, lithium, lithium-ion, zinc-carbon, and alkaline batteries. In the figure, battery 202 is identified as a 3.7V battery, although it is understood that other voltage batteries could be used. In other implementations, other sources or power can be used, such as solar, or, device 200 can be hard wired to a power source. Electrically connected to battery 202 are a battery level monitor (not specifically shown) and a power control 204, which in turn is operably connected to a computer chip or CPU 206.

Wireless dosimeter device 200 also includes a positioning element 208 that determines and provides data to wireless dosimeter device 200 regarding its physical location. In the implementation of FIG. 2, positioning element 208 is a GPS positioning element 209 connected to an antenna 210, which may be an internal antenna or an external antenna, which may be embedded into a housing encasing the elements of device 200. Antenna 210 may be, for example, a planar inverted F antenna, an inverted L antenna, or a monopole antenna. Antenna 210 may be a multi-band antenna, one that can transmit and receive signals in multiple frequency bands. Positioning element 208 may include mobile station-assisted (MSA) operation to enable accurate positioning at locations where GPS is unavailable or impaired.

Wireless dosimeter device 200 transmits information or data, such as radiation levels detected, its location, etc., to the remote host (e.g., receiver 104 of FIG. 1) via a wireless network, such as ZigBee and/or BLE. In some implementations, wireless dosimeter device 200 has two-way communication with a remote host. That is, wireless dosimeter device 200 transmits information such as location, sensor information, etc. and also receives information from the remote host. Further, wireless dosimeter device 200 receives instructions, such as to acknowledge that device 200 is active and ready and to transmit the location and/or radiation information. Having received those instructions, wireless dosimeter device 200 can send back to the remote host acknowledgement that the communication was received and acted on.

As indicated, the wireless dosimeter device 200 is configured to send and optionally receive data via a wireless network. Wireless dosimeter of FIG. 2 is configured with an RF communication module 212, such as a ZigBee/BLE module, to connect to the remote host via a ZigBee network or a BLE (Bluetooth low energy) network and communicate data (e.g., position data) to the remote host. An alternate implementation of a wireless dosimeter device can utilize a ZigBee/WiFi module and a corresponding ZigBee/WiFi network.

Wireless dosimeter device 200 also includes a cellular communication module 214, which may be CDMA (Code Divisional Multiple Access) and/or GSM (Global System for Mobile Communication) module, configured to connect to the receiver via either a CDMA or GSM network and communicate data to the receiver.

Communication modules 212, 214 may each or together have an antenna 216 that can optionally include a power amplifier 218 to extend the range of the signal from modules 212, 214. In some implementations, modules 212, 214 may be combined into a single physical module rather than two separate or distinct modules. Together, modules 212, 214 provide the communication basis for wireless dosimeter device 200 to and from the remote host. RF module 212, which connects wireless dosimeter device 200 to a wireless RF network, can be utilized when infrastructure is available to use of RF communications; cellular module 214, which connects wireless dosimeter device 200 to a cellular network, can be utilized, for example, in situations when infrastructure is unavailable for using RF communications yet cellular communication is allowed.

Any of the data or information regarding wireless dosimeter device, such as radiation level and time detected, its position as determined by positioning element 208, alarm information, battery level information, etc., can be stored in a memory 220 of wireless dosimeter device 200, which may be a permanent memory or a rewritable (e.g., nonvolatile) memory.

Wireless dosimeter device 200 includes a motion sensor array 222 to determine the orientation, location and/or movement of wireless dosimeter device 200. A particular example of a motion sensor array 222 is a 10-degree of freedom (DOF) device that includes a 3-axis gyroscope, 3-axis accelerometer, 3-axis magnetometer, and an altitude sensor. Other implementations of motion sensor array 222 may be used; for example, a single degree of freedom (DOF) device having a single axis accelerometer or a three degree of freedom (3-DOF) device having a 3-axis accelerometer or a six degree of freedom (6-DOF) device having a 3-axis gyroscope and a 3-axis accelerometer. Another example of a suitable configuration for motion sensor array 222 includes a 9-DOF device that includes a 3-axis gyroscope, a 3-axis accelerometer and a 3-axis magnetometer. By sensing the various multiple degrees of freedom, wireless dosimeter device 200 can distinguish among various movements, orientations and locations, such as lateral motion, acceleration, inclined or declined motion, and altitude.

Wireless dosimeter device 200 can additionally include a temperature sensor, a wind sensor, and a chemical sensor. A temperature sensor measures local temperature of the wireless dosimeter device. A wind sensor determines wind speed and direction at the wireless dosimeter device. A chemical sensor provides information about the chemical composition of its environment either in a liquid or a gas phase.

Additionally, wireless dosimeter device 200 may include application-programming interface (API) 224 that specifies how some software components should interact with each other in a resource constrained environment. Constrained application protocol allows the remote host to control the wireless dosimeter through standard Internet networks; the protocol is designed to easily translate to HTTP for simplified integration with the web, while meeting specialized requirements such as multicast support, very low overhead, and simplicity.

Wireless dosimeter device 200 may also include an indicator console 226 having various operational switches, gauges, buttons, and/or lights (e.g., LED lights); in the particular implementation shown, indicator console 226 has 3 LED lights and 2 buttons. Console 226 may include any number of optional features, such as an audio alarm to indicate any number of problems or malfunctions, such as high radiation level, low battery level, or tampering with wireless dosimeter device in any manner, as sensed by a tamper switch.

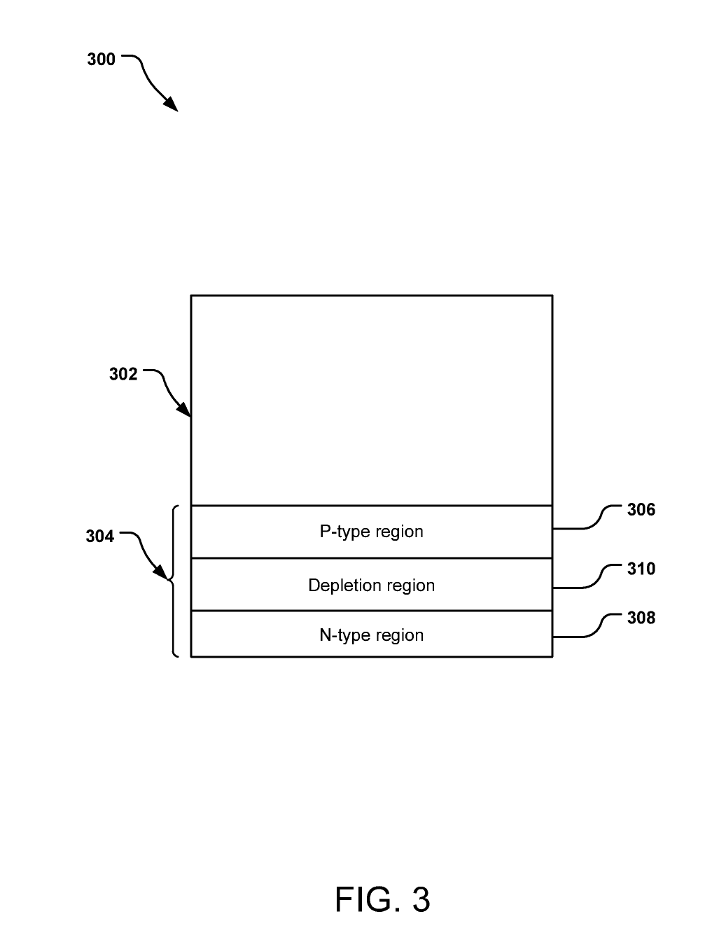

Wireless dosimeter device 200 includes a micro dosimeter 228 to detect radiation. In the particular implementation illustrated, micro dosimeter 228 is an integrated scintillator dosimeter, in which energy absorbed from incident radiation or charged particles is converted into a light by a scintillator material. The scintillator material is integrated directly on a silicon photodiode, such as shown in FIG. 3, and the silicon photodiode then converts the generated light into an electrical signal. Here, a total ionizing dose (TID) is measured indirectly through the generated light of the integrated scintillator.

FIG. 3 provides an example of integrated scintillator dosimeter 300, having a scintillator layer 302. There are a number of materials that can be used as scintillator layer 302, depending on variables such as energy range, type of radiation to be detected, environmental constraints, deposition technology, etc. Examples of suitable scintillator materials include bismuth germanate (Bi₄Ge₃O₁₂), cadmium tungstate (CdWO₄), and cesium iodide. A thickness of scintillator layer 302 can be between 500 to 10000 micrometers. The scintillator material 302 is present (typically, deposited) directly on a silicon photodiode 304. In some implementations, a PIN photodiode with a thickness less than 10 micrometers is used as silicon photodiode 304. A PIN photodiode has a P-type region 306, an N-type region 308 with an intrinsic layer 310 therebetween. Both the P- and N-type regions 306, 308 of the PIN photodiode can be heavily doped. A generated light (photon) from the absorbed energy will be converted into an electrical signal at the highest conversion factor by the silicon photodiode 304; this reduces a potential mechanism loss from the absorbed energy from the absorbed photon in the silicon photodiode.

An integrated scintillator dosimeter can have low power consumption and low noise characteristics. It can be made on a single silicon chip containing all readout electronics for the micro dosimeter with battery operated supply voltage, typically in a range of 1.8-5 V and in an environmentally sealed package. The integrated scintillator dosimeter is particularly suitable for a portable, wireless, and battery operated dosimeter device such as dosimeter device 200.

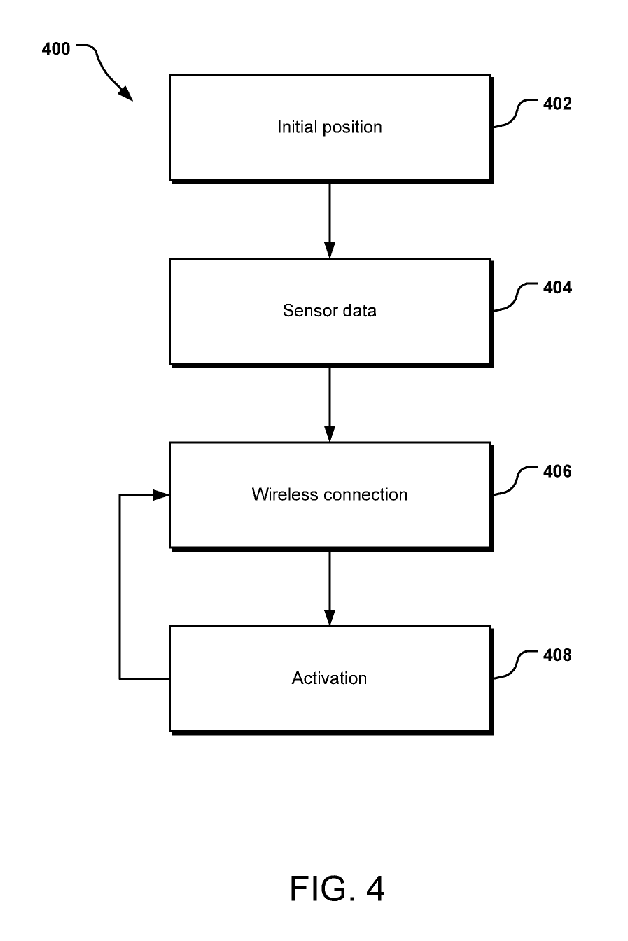

FIG. 4 shows an example method 400 of monitoring radiation exposure for an environmental dosimeter system having a plurality of wireless dosimeter devices, each wireless dosimeter according to the disclosure. Method 400 includes an initial positioning operation 402, when the wireless dosimeter devices are activated and the initial position of each wireless dosimeter is established. In a collection operation 404, at least one wireless dosimeter collects sensor data. After data has been collected, in a connection operation 406, the dosimeter establishes a wireless connection with its remote host, sends its position and collected sensor data to the remote host, and optionally acknowledges a new instruction from the remote host. After connecting with the receiver, the wireless dosimeter may enter a sleep mode, e.g., to converse the battery. From any sleep mode, the dosimeter activates in operation 408 and returns to the connection operation 406, sensing any new position and collected sensor data to the remote host. In an alternate method, the dosimeter activates in operation 408 and returns to the connection operation 406.

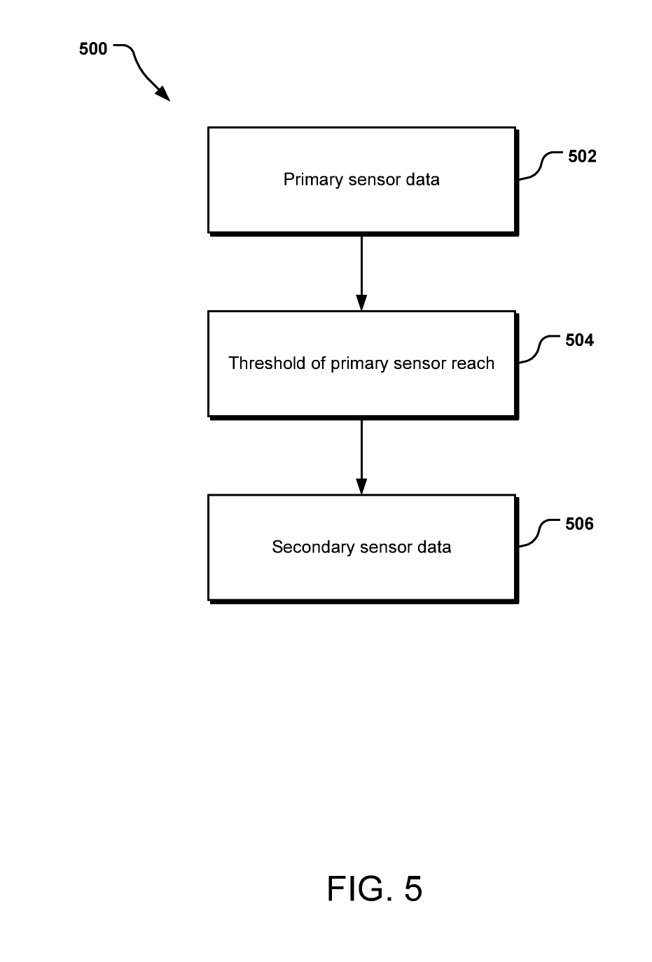

FIG. 5 shows an example method 500 for collecting sensor data from a wireless dosimeter device (e.g., dosimeter device 200). Method 500 includes operation 502 where sensor data are collected from the primary micro dosimeter 228; in some implementations, data from a temperature sensor, if present, is also collected. In operation 504, if the pre-determined threshold of the primary data (e.g., as set by the user) is reached, the CPU of the wireless dosimeter device collects secondary sensor data in operation 506, for example, data from a chemical sensor and/or wind sensor, if present. With this information, a total exposure dose can be calculated, as well as a prediction of radiation spread.

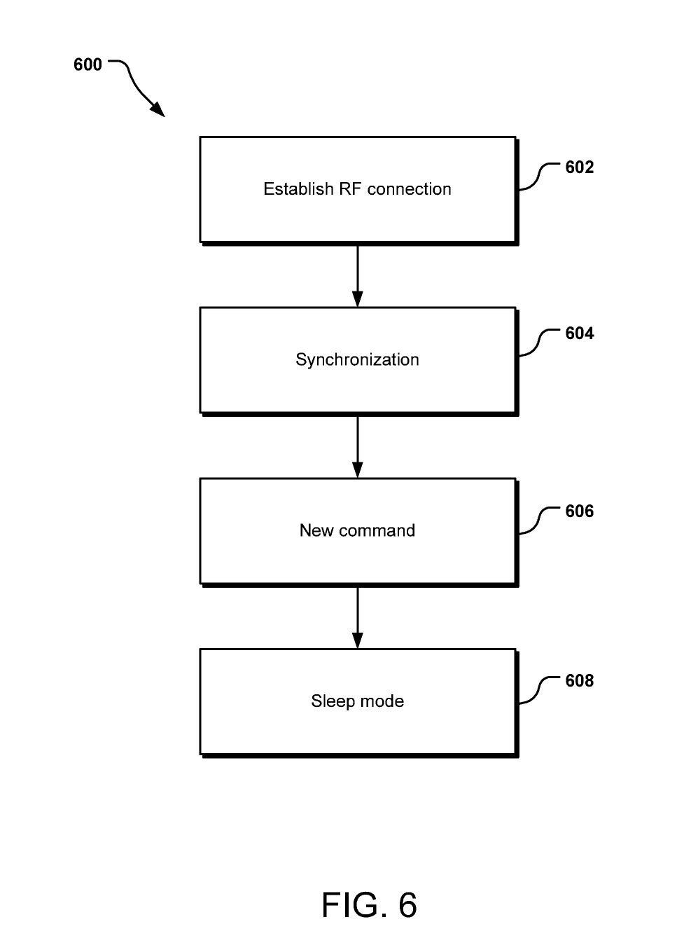

FIG. 6 shows an example method 600 for wireless connection of a wireless dosimeter (e.g., dosimeter device 200). Method 600 includes operation 602 where, when infrastructure is available to use of RF communications, an RF connection is established via an RF network between the wireless dosimeter and a remote host; in situations when infrastructure is unavailable for using RF communications yet cellular communications is allowed, a cellular network will be utilized. In operation 604, the wireless dosimeter is synchronized with the remote host. Once synchronized, the remote host can provide the dosimeter with new instructions in operation 606, and the wireless dosimeter will execute those new instructions. In operation 608, the dosimeter goes to a sleep mode, e.g., to conserve the battery.

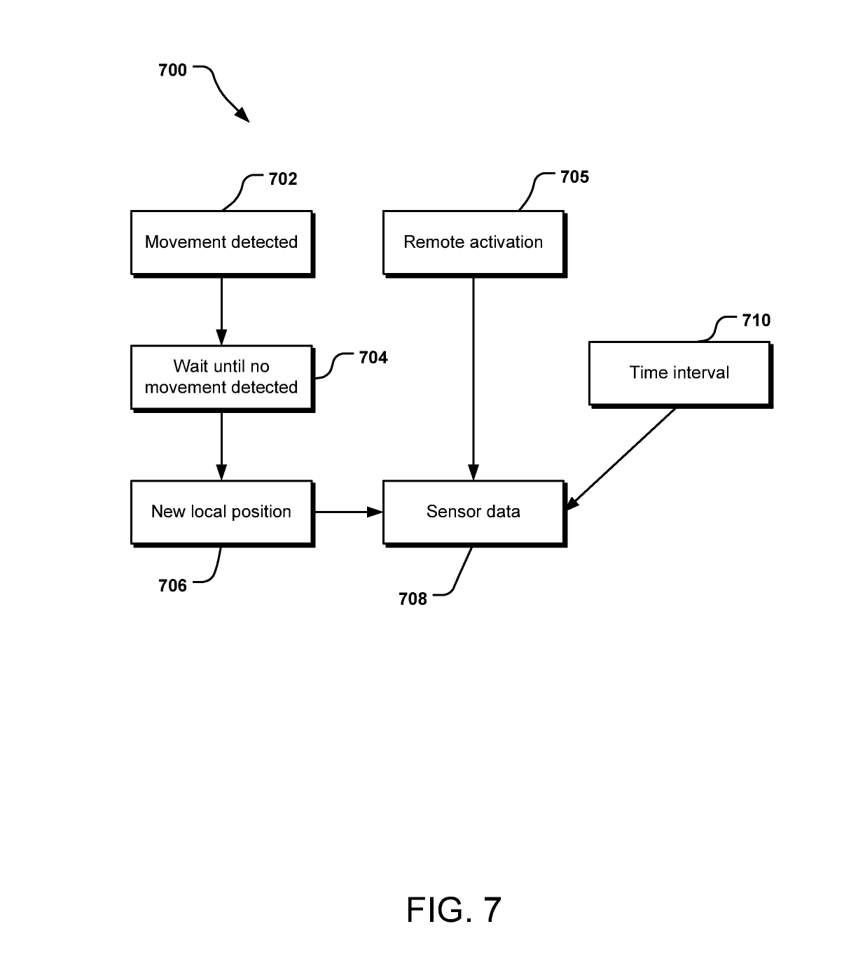

FIG. 7 shows an example method 700 for activating a wireless dosimeter, for example, from a sleep mode. This method 700 includes three possible modes to activate the wireless dosimeter. In a first mode, shown as operation 702, the wireless dosimeter is activated by the movement. In a second mode, shown as operation 705, the wireless dosimeter is activated by a remote activation, such as from the remote host (during the sleep mode, the wireless dosimeter is also in the listening mode). In a third mode, shown as operation 710, the wireless dosimeter is activated by pre-determined time interval set by the user. A wireless dosimeter can be configured to activate from one or any combination of these modes.

If the activation mode is movement (i.e., operation 702), when movement is detected by the motion sensor of the dosimeter, the wireless dosimeter will wake up (go into ready mode) and remain active until no more movement is detected (operation 704), after which the wireless dosimeter will activate the GPS module, and get its new location data in operation 706. When ready, the wireless dosimeter will collect sensor data in operation 708.

If the activation mode is via a remote activation, such as by the host (i.e., operation 705), when active, the wireless dosimeter will send an acknowledgement to the remote host, and goes to ready mode. After the wireless dosimeter is in the ready mode, the wireless dosimeter will collect sensor data in operation 708. In some implementations, the dosimeter will also activate the GPS module and get its new location.

If the activation mode is based on a time interval (i.e., operation 710), the dosimeter will wake up automatically once the timer is up and go to ready mode. After the wireless dosimeter is in the ready mode, the wireless dosimeter will collect sensor data in operation 708. In some implementations, the dosimeter will also activate the GPS module and get its new location.

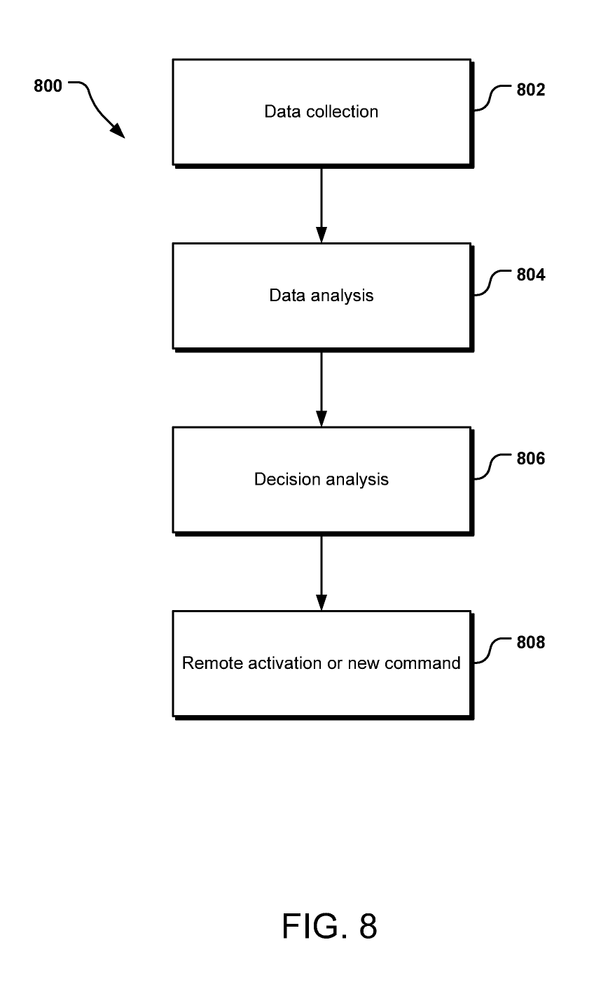

FIG. 8 illustrates a generic method 800 at the remote host (e.g., receiver 104). In operation 802, data are collected from plurality of wireless dosimeter devices (e.g., dosimeter devices 102, 200) including location of the dosimeter device and sensor data. After data has been collected, the system analyzes the data in operation 804. The analysis may include data present in a memory of the receiver, the data having been previously collected from the dosimeter device. A decision analysis is conducted in operation 806 based on pre-determined settings by the user; in some cases, the data is presented on a display screen. In operation 808, the remote host may active a particular wireless dosimeter device or may send a new instruction to selected or all wireless dosimeter devices in the system.

Numerous variations of method 800 are foreseen. For example, method 800, or similar method, may further include storing the data related to the level of radiation measured by the wireless dosimeter device. Methods may also include calculating the maximum stay time based on the data related to the level of radiation stored in the memory and the data related to the level of radiation instantaneously measured by the wireless dosimeter.

Method 800, or similar method, may further include providing a maximum exposure dose. Methods may also include calculating the maximum stay time based on the data related to the level of radiation stored in the memory, the data related the level of radiation instantaneously measured by the wireless dosimeter, and the maximum exposure dose. Methods may include calculating the maximum stay time based on the data related to the level of radiation measured by the wireless dosimeter and the maximum exposure dose.

Thus, various implementations of the RADIATION EXPOSURE MONITORING DEVICE AND SYSTEM are disclosed. The various wireless dosimeter devices and systems described above have benefits over previous devices and systems, including Cloud-based data handling for central/distributed control and 128 bit AES security encryption. The devices can be battery operated with optional solar panel or line power, they can be over-the-air (OTA) and firmware-over-the-air (FOTA) for self-diagnostic, remote formatting/updating, and they can have smart analytics for actionable decision making (time and event based event). Further, they can have a universal interface for sensor integration (chemical, temperature, wind etc.) and have wireless communication capability (e.g., Zigbee, WiFi, LTE, etc.) with GPS creating counter map with GPS position and real time progression map.

The implementations described above and other implementations are within the scope of the following claims. One skilled in the art will appreciate that the present invention can be practiced with implementations other than those disclosed. The disclosed implementations are presented for purposes of illustration and not limitation, and the present invention is limited only by the claims that follow.

What is claimed is:

1. A radiation monitoring system comprising:
a plurality of wireless dosimeter devices, each dosimeter device comprising:
an integrated dosimeter,
a positioning unit,
a battery, and
a control unit operably connected to a wireless transceiver for transmission of data representative of the radiation data detected by each dosimeter; and
a remote host comprising a wireless transceiver suitable for communicating with the wireless dosimeter devices.

2. The system of claim 1, wherein the integrated dosimeter is a solid state dosimeter.

3. The system of claim 2, wherein the solid state dosimeter comprises at least a scintillator and silicon photodiode.

4. The system of claim 1, wherein at least one of the wireless dosimeter devices is not equipped with a display screen.

5. The system of claim 1, wherein each of the wireless dosimeter devices is not equipped with a display screen.

6. The system of claim 1, wherein the wireless transceiver of the wireless dosimeter devices includes an RF transceiver.

7. The system of claim 6, wherein the wireless transceiver of the wireless dosimeter devices further includes a cellular transceiver.

8. The system of claim 7, wherein the cellular transceiver of the wireless dosimeter devices further include a real time display.

9. The system of claim 7, wherein the cellular transceiver of the wireless dosimeter devices further include an alarm or a control

10. The system of claim 1, further wherein the wireless transceiver of the wireless dosimeter devices is for transmission of position data of the dosimeter device.

11. A method of radiation exposure monitoring using a system having at least one wireless environmental dosimeter device and a remote host, the method comprising:
a) activating the wireless dosimeter device and establishing an initial position of the wireless dosimeter device;
b) collecting sensor data from the wireless dosimeter device; and
c) establishing a wireless connection between the wireless dosimeter device and the remote host, and sending position and sensor data from the wireless dosimeter device to the remote host.

12. The method of claim 11 further comprising, after sending position and sensor data:
d) acknowledging new instruction from the remote host.

13. The method of claim 12, after acknowledging new instruction from the remote host:
e) the wireless dosimeter device goes to sleep mode.

14. The method of claim 13, further comprising, after sleep mode:
f) going to an activation step.

15. The method of claim 11, wherein activating the wireless dosimeter device is by movement.

16. The method of claim 11, wherein activating the wireless dosimeter device is by remote activation from the remote host.

17. The method of claim 11, wherein activating the wireless dosimeter device is by a pre-determined time interval.

18. The method of claim 11, wherein collecting sensor data comprises:
a) collecting primary sensor data from a micro dosimeter and reading a temperature sensor, and
b) if a pre-determined threshold of the primary data set by the user are reached, the CPU of the wireless dosimeter collects secondary sensor data for example data from chemical sensor and/or wind sensor.

19. A method for wireless connection of a wireless dosimeter device, the method comprising:
a) establishing an RF connection between the wireless dosimeter device and a remote host,
(i) when infrastructure is available to use of RF communications, using a wireless RF network,
(ii) when infrastructure is unavailable for using RF communications, using a cellular network;
b) synchronizing the wireless dosimeter device with the remote host; and
c) the wireless dosimeter device going to a sleep mode to conserve the battery.

20. The method of claim 19, prior to the wireless dosimeter device going to a sleep mode, further comprising:
i) the remote host providing instructions to the wireless dosimeter device; and
ii) the wireless dosimeter executing the instructions

21. The method of claim 19, after the wireless dosimeter device going to a sleep mode to conserve the battery, further comprising:
d) waking up after a timer has expired, and
e) progressing to a ready mode,
f) after the ready mode, progressing to a collection sensor data step.

22. The method of claim 19, after the wireless dosimeter device going to a sleep mode to conserve the battery, further comprising:
d) waking up the dosimeter device when movement is detected by a motion sensor;
e) remaining awake until no more movements are detected by the motion sensor;
f) activating a GPS module, and gathering location data;
g) progressing to a ready mode; and
h) after the ready mode, progressing to a collection sensor data step.

23. The method of claim 22, further comprising:
i) sending an acknowledgement from the dosimeter device to the remote host;
ii) entering a ready mode; and
iii) after the ready mode, progressing to a collection sensor data step.
